(19) United States
(12) Patent Application Publication
(10) Pub. No.: US 2005/0257884 A1
(43) Pub. Date: Nov. 24, 2005

(54) Positioning method in manufacturing process of electronic elements

(76) Inventors: Sheng Yuan Liu, Taichung Hsien (TW); Sheng Feng Liu, Taichung Hsien (TW)

Correspondence Address: Liu Sheng Yuan, 235 Chung - Ho, Box 8-24, Taipei, TW

(21) Appl. No.: 10/851,960

(22) Filed: May 24, 2004

(51) Int. Cl. B32B 31/00

(52) U.S. Cl. 156/291

(57) ABSTRACT

A positioning method in the manufacturing process of electronic elements comprises the steps of: dropping positioning glue on a working table; drying the positioning glue; placing a work piece upon the positioning glue so as to fix the work piece; performing other processes; checking whether the positioning glue is available; if yes, repeating the process for another work piece; and if not, cleaning the positioning glue from the work piece and repeating the process for the work piece.

### FIELD OF THE INVENTION

The present invention relates to gluing process, and particular to a positioning method in the manufacturing process of electronic elements.

### BACKGROUND OF THE INVENTION

With reference to FIG. 1, a prior art positioning method in the manufacturing process of electronic elements is illustrated. A double face tape 3 or tape 4 are used to fix a work piece 5. The positioning can be performed manually and as a result the manufacturing process is speeded. The tape has the problem of thermal expansion and the chemical adhesive will dirt the working table and the work piece. Thereby, the chemical adhesive cannot be removed easily. As the process is used repeatedly for a long time, the adhesive will adhere on the working table so as to increase the width of the working table. As a result the precision of the work piece is affected. In the manually adhering process, the work piece easily slides or shifts. Furthermore, the chemical adhesive is liquid. After adhered, the work piece will shift due to shock, such as earthquake. In general, the electronic elements must have higher precision. For example, the general communication elements or circuit printed boards cannot endure a shift of over 0.2 mm otherwise the work piece will be deserted. Furthermore, the prior art way cannot be used to the variety of handset components. Although the prior art way can be used in vacuum positioning, the cost is very high and thus it is not suitable for business competition.

### SUMMARY OF THE INVENTION

To achieve above objects, the present invention provides a positioning method in the manufacturing process of electronic elements which comprises the steps of: dropping positioning glue on a working table; drying the positioning glue; placing a work piece upon the positioning glue so as to fix the work piece; performing other processes; checking whether the positioning glue is available; if yes, repeating the process for another work piece; and if not, cleaning the positioning glue from the work piece and repeat the process for the work piece.

The various objects and advantages of the present invention will be more readily understood from the following detailed description when read in conjunction with the appended drawing.

### BRIEF DESCRIPTION OF THE DRAWINGS

FIG. 1 shows the positioning method in the manufacturing process of electronic elements according to the present invention.

FIG. 2 shows the block diagram of the present invention.

FIG. 3 shows one embodiment of the present invention.

FIG. 4 shows a further embodiment of the present invention.

FIG. 4-1 shows a cross section view of the embodiment illustrated in FIG. 4.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

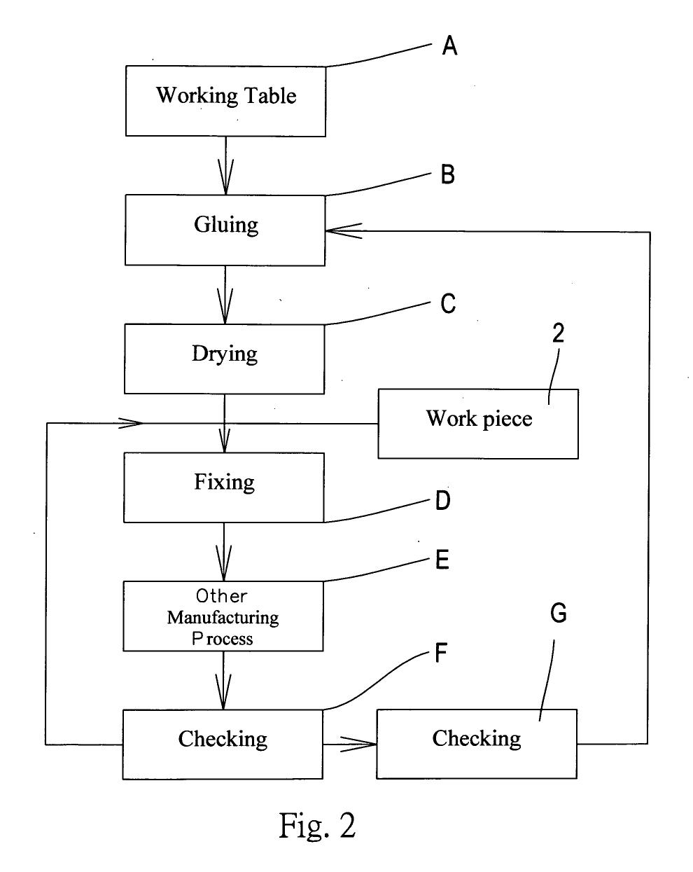

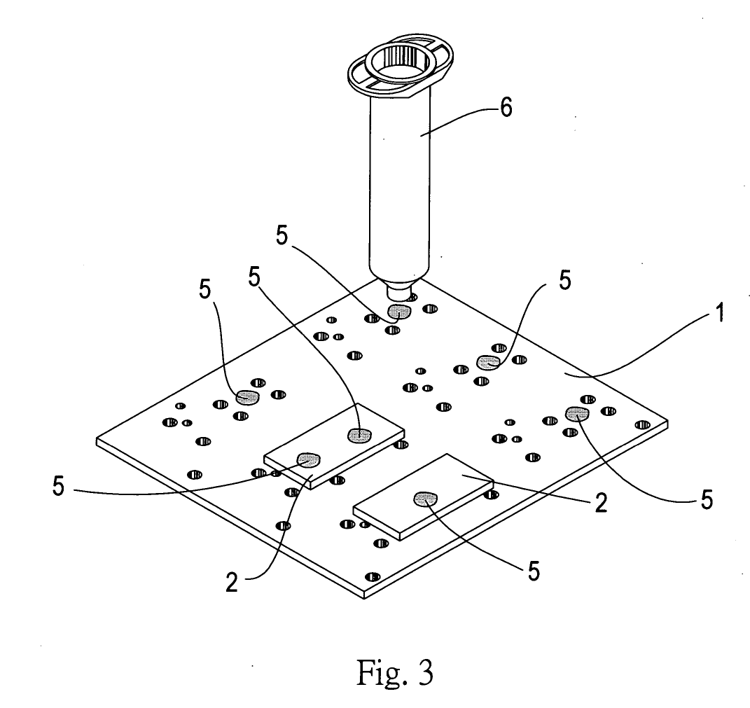

With reference to FIGS. 2 and 3, the positioning method in the manufacturing process of electronic elements. The method comprises the following process of: dropping positioning glue on a working table 1 (step A, B); drying the positioning glue (step C); placing a work piece 2 upon the positioning glue 5 so as to fix the work piece (D); performing other processes (step E); checking whether the positioning glue is available (F); if yes, repeating the process for another work piece; if not, cleaning the positioning glue from the work piece and repeat the process for the work piece (G). In the present invention, the positioning glue can be used several hundred times and the alcohol can be used to clean the glue or the glue can be removed by scraping.

In the drying process C, the winding drying or heating drying is used to evaporate volatile or evaporated liquid within the glue so as to solidify the glue. The positioning glue 5 is liquid rubber compound which can endure a high temperature of several degrees. The physical features of the glue will not change due to the characteristics of the electronic elements. The glue has special extension and cohesion force. When the glue contacts the work piece, capillary effect will induce so as to become adhesive without using any chemical agent.

With reference to FIG. 3, in the present invention, the positioning glue 5 is outputted from a glue supply device 6 on a table 5. After the glue 5 is dried, a work piece 2 is placed on the positioning glue 5. Then other manufacturing processes are performed. The present invention can be used in curved work pieces, such as an S shape work piece.

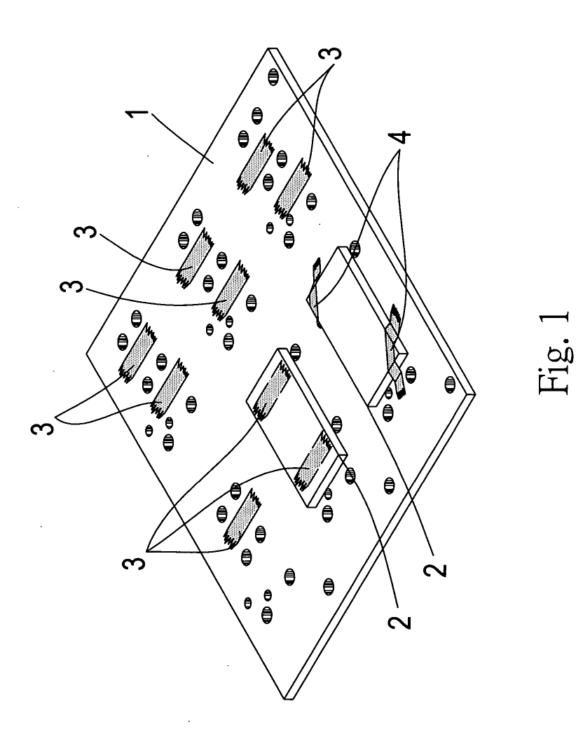

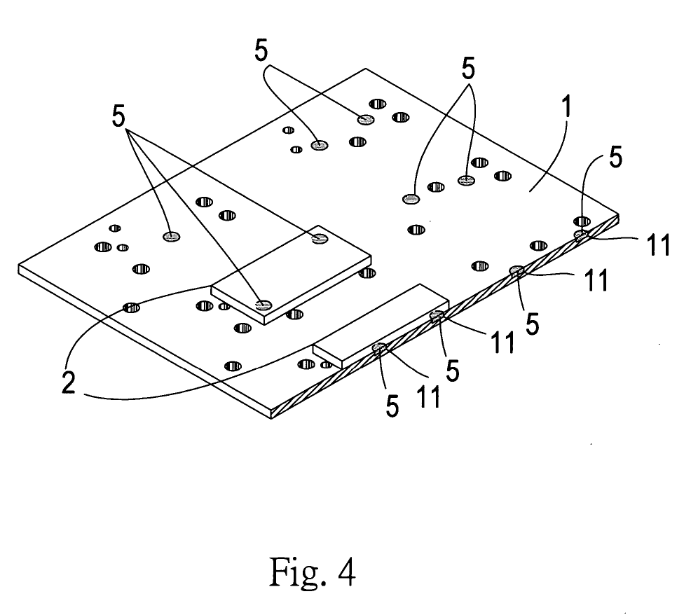

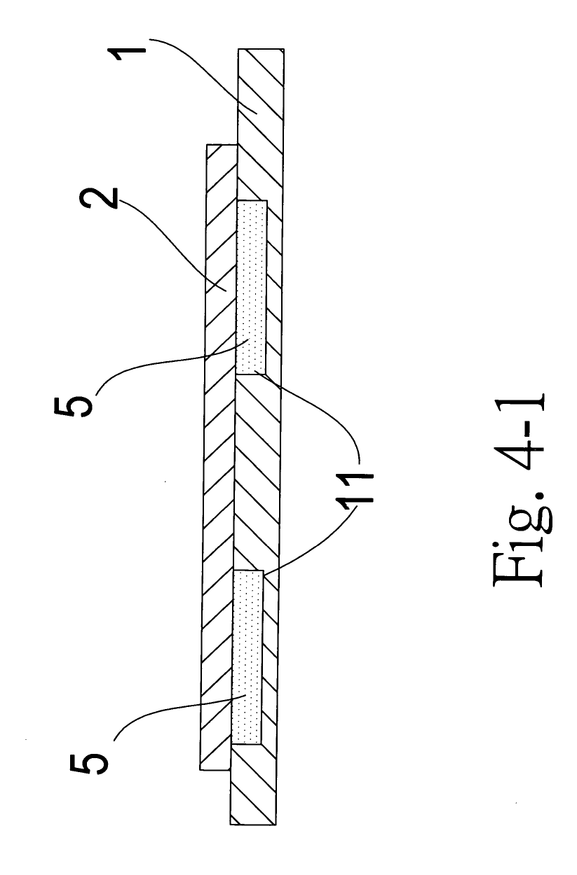

With reference to FIGS. 4 and 4-1, a limiting groove 11 is formed on the table 1. Then the positioning glue is placed in the limiting groove 11. Then the other processes are positioned as above said so that the positioning glue will not greatly change the width of the work piece.

Advantages of the present invention will be described herein. The present invention can be performed rapidly. The glue can be cleared conveniently by scraping or alcohol with solvents without damaging the worktable. The operation of the present invention can be performed automatically instead of manual operation so as to improve the working process. After positioning the work piece, the work piece will not slide. The glue can be used repeatedly several hundred times and the glue is adhered only at some points. Thereby, the present invention can be used curved work piece, such as an S shape work piece. If the present invention is used to a precise mold, the working table can be etched and then the glue is added and then solidified so as to have a higher precision.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A positioning method in the manufacturing process of electronic elements comprising the steps of:
dropping positioning glue on a working table;
drying the positioning glue;
placing a work piece upon the positioning glue so as to fix the work piece;
performing other manufacturing processes;
checking whether the positioning glue is available;
if yes, repeating the process for another work piece; and
if not, cleaning the positioning glue from the work piece and repeating the process for the work piece.

2. The positioning method in the manufacturing process of electronic elements as claimed in claim 1, wherein the positioning glue is outputted from a glue output device.

3. The positioning method in the manufacturing process of electronic elements as claimed in claim 1, wherein in the drying step, the drying is performed by blowing winding or heating so as to evaporate volatile or evaporated liquid within the glue to solidify the glue.

4. The positioning method in the manufacturing process of electronic elements as claimed in claim 1, wherein the positioning glue is liquid rubber compound which endures a high temperature of several degrees; the physical features of the positioning glue will not change due to the characteristics of the electronic element; the glue has special extension and cohesion force; when the glue contacts the work piece, capillary effect will induce so as to become adhesive without using any chemical agent.
